(19) United States
(12) Patent Application Publication
(10) Pub. No.: US 2022/0056275 A1
(43) Pub. Date: Feb. 24, 2022

(54) SILICON- AND ZINC-CONTAINING COUPLING AGENT FOR CELLULOSIC MATERIAL-POLYMER COMPOSITES

(71) Applicant: Arkema Inc., King of Prussia, PA (US)

(72) Inventors: William P. PAVLEK, Stevens, PA (US); Peter R. DLUZNESKI, Harleysville, PA (US); Leonard H. PALYS, Downingtown, PA (US); Michael B. ABRAMS, Bala Cynwyd, PA (US); Marina DESPOTOPOULOU, Havertown, PA (US)

(21) Appl. No.: 17/495,051

(22) Filed: Oct. 6, 2021

Related U.S. Application Data
(63) Continuation-in-part of application No. PCT/US2021/026413, filed on Apr. 8, 2021.
(60) Provisional application No. 63/007,424, filed on Apr. 9, 2020.

(51) Int. Cl. C08L 99/00; C08H 99/00; C08J 3/22

(52) U.S. Cl. CPC C08L 99/00; B29B 7/48; C08J 3/226; C08H 99/00

(57) ABSTRACT

A coupling agent formulation for cellulosic material-polymer composites is provided. The formulation includes a) at least one organic peroxide; and b) at least one of i) at least one zinc-containing reagent; and/or ii) at least one silicon-containing reagent. The coupling agent formulations produce polymer matrix cellulosic material composites with improved strength and aging characteristics. The improved strength may be related to physical properties such as improved stiffness, toughness or tensile strength. A masterbatch utilizing the coupling agent formulation is provided, as well as a method making the masterbatch.

### CROSS REFERENCE TO RELATED APPLICATIONS

This application is a continuation in part of and claims priority from PCT/US2021/-26413, filed Apr. 8, 2021, which claims priority to U.S. Ser. No. 63/007,424, filed on Apr. 9, 2020, the entire contents of both of which are incorporated by reference herein for all purposes.

### FIELD OF THE INVENTION

This disclosure relates to coupling agent formulations for improving the properties of cellulosic material-polymer composites. The technology is applicable to a range of cellulose-based materials, such as wood or wood products as the filler in such polymer matrix composites.

### BACKGROUND OF THE INVENTION

Melt blending a combination of cellulosic material (such as wood flour) and polymers in an extruder to form boards that mimic lumber is a commercial process to make cellulosic material-polymer composite decking, fencing and siding. Cellulosic material and polymers tend to be mutually incompatible. For example, the cellulosic material-polymer composite decking, fencing or siding may exhibit poor aging, which is often caused by excessive water uptake from the environment. These type of composites also tend to suffer from creep, i.e., a slow bending of the material over a period of time. Creep is exacerbated in vertical applications such as fencing and siding. The current approach to solve this incompatibility problem is to incorporate a commercially available maleic anhydride grafted polymer into the cellulosic material-polymer matrix blend. The maleic anhydride grafted polyethylene (MAH-g-PE) or maleic anhydride grafted polypropylene (MAH-g-PP) polymers are referred to as polymeric compatibilizers or polymeric coupling agents and may be expensive. Commercially known maleated polyolefins include Polybond® series from Chemtura, Fusabond® series from DuPont, Exxelor® series from ExxonMobil and Orevac® series from Arkema. These additives may not provide a composite that is sufficiently rigid to perform well as fencing or siding. Further, physical properties of the present technology for compatibilizers may not provide sufficient rupture resistance as measured by modulus of rupture (MOR), or stiffness as measured by modulus, which is related to resistance to creep.

Poor compatibilization of cellulosic material and polyethylene or polypropylene or other non-polar polymers or blends thereof leads to cracks in the composite board, a decrease in the board's physical properties and an increase in water absorption. Water absorption decreases the composite's aging characteristics, i.e., retention of physical properties over time. There is a need for coupling additives that build mechanical strength and reduce water absorption, especially for load-bearing applications and even more particularly for such load bearing applications that are exposed to an outside environment, for example for cellulosic material-polymer composites such as wood-polymer composite boards intended to be used for outdoor decking, fencing or siding.

US 2020/0056020 discloses a capstock resin for wood polymer composites. A building material may be composed of the capstock with a wood-polymer composite core, in which the capstock and core are co-fabricated. The capstock and core may be include polymer resins including LLDPE, LDPE, MDPE, HDPE, UHMWPE, a polyamide, PET, PP, or PVC.

US 2017/0275462 is directed to compositions comprising a thermoplastic polymer, cellulosic material and a functional filler, wherein the functional filler comprises an inorganic particulate preferentially based on calcium, magnesium, or aluminum and a surface treatment agent on a surface of the inorganic particulate.

US 2014/0121307 discloses use of a modified lignin, hydroxypropyl lignin (HPL), HDPE, LDPE (low density polyethylene), PP and polystyrene. Hydrogen peroxide is blended with a polymeric compatibilizer. The compatibilizer disclosed is the standard grafted MAH on polyethylene (MAH-g-PE) or a copolymerized polyethylene where the MAH is in the polymer chain versus grafted onto the chain.

US 2004/0126515 discloses using a polyethylene polymer blended with wood particles to produce a composite. The polyethylene in this application has a melt flow index (MFI) of less than about 2 g/10 min. Also disclosed is a bonding agent which is a polymer having an MFI greater than the polyethylene used in the wood-plastic composite. This bonding agent is a carboxylic acid or anhydride species that is chemically bonded to a polyethylene chain before use in a wood plastic composite. The application also discloses that wood lignin and terpenes in a wood-plastic composite can result in undesirable foaming.

U.S. Pat. No. 5,179,149 discloses the use of stand oils. The final material, referred to as the stand oil intermediate product is ground up to a powder for use to make nonwoven products. In a further step, the stand oil intermediate product is added to ethylenepropylene diamine monomer (EPDM), wood filler, PE, clay and t-butylperoxy benzoate, mixed and then pressed into a sheet and cured at 140° C.

U.S. Pat. No. 7,850,771 discloses preparing aqueous emulsions of polyethylene wax, wood preservatives and optional agents such as tung oil, linseed oil, acrylic acid, organic acids using as free radical initiators azobisisobutyronitrile (AIBN) and hydrogen peroxide that make up the wood preservative composition. The patent discloses the use of alkyl acrylates that can be cured with AIBN, hydrogen peroxide, or potassium persulfate.

There remains a need for a cost-effective, easy-to-use coupling agent for cellulosic material-polymer composites that have suitable aging resistance and physical properties to be used as replacements for traditional wood lumber, particularly for outdoor applications such as decking, fencing and siding.

### SUMMARY OF THE INVENTION

The inventors have found that a specific formulation including an organic peroxide, at least one of a zinc-containing reagent or a silicon-containing reagent, or a combination of both provide a coupling agent for polymer matrix composites with cellulosic materials (such as wood) as a filler. This formulation is cost-effective and imparts improved water uptake, modulus of rupture and stiffness (high modulus) to cellulosic material-polymer composites.

A coupling agent formulation for cellulosic material-polymer composites is provided. The formulation comprises, consists of or consists essentially of:

a) at least one organic peroxide, wherein the at least one organic peroxide has a half-life of at least one hour at 98° C.; and

b) at least one of i) at least one zinc-containing reagent; and/or ii) at least one silicon-containing reagent having structure (I):

SiR¹R²R³R⁴ (I).

In structure (I), at least one of R¹, R², R³, or R⁴ comprises, consists of or consists essentially of at least one unsaturation and the remaining R¹, R², R³, or R⁴ are hydrogen or alkyl or alkoxy groups and may be the same or different.

Also provided is a masterbatch of the coupling agent for polymer matrix composites with wood and/or other cellulosic materials as a filler. The masterbatch comprises, consists of or consists essentially of the above coupling agent formulation and a suitable carrier. Typically, the masterbatch is provided as a powdery or pelleted solid. Methods of preparing the masterbatch are also disclosed, as well as methods of making cellulosic material-polymer composites.

In summary, disclosed are coupling agent formulations that may be added separately or as a masterbatch to cellulosic materials and polymers. This final composition is then melt blended and extruded to form, for example, cellulosic material-polymer composite deck boards, fencing or siding.

In one embodiment, the coupling agent may completely replace the conventional polymeric grafted MAH compatibilizers in a cellulosic material-polymer composite formulation.

In another embodiment, the coupling agent formulation may partially replace a conventional polymeric MAH coupling agent in a cellulosic material-polymer composite.

### DETAILED DESCRIPTION

The following description is merely exemplary in nature and is in no way intended to limit the present disclosure or its application or uses.

Unless otherwise indicated, all percentages herein are weight percentages.

“Polymer” as used herein, is meant to include organic molecules with a weight average molecular weight higher than 20,000 g/mol, preferably higher than 50,000 g/mol, as measured by gel permeation chromatography.

The term, “dry” as used herein with respect to the cellulosic filler for the cellulosic material-polymer composite, means up to and including, 0 wt % to 1 wt % to 2 wt % but no more than 5 wt % of water as measured by thermogravimetric analysis as weight loss until a constant mass has been achieved when heating the cellulosic filler filler at 103° C. This method is described in “Methods to determine wood moisture and their applicability in monitoring concepts” by Philipp Dietsch et al. ([Journal of Civil Structural Health Monitoring; Vol 5, p. 115-127 (2015)]. In addition, a device called “Sawdust moisture meter TK100W” from KJ Industry Co. Ltd. has a 0 wt % to 84 wt % moisture measuring range. This device can be used to measure the moisture content of various cellulosic materials such as wood flour, sawdust, paillasse and bamboo powder.

“Coupling agent” as used herein means a substance or combinations of substances that may react with both the cellulosic material and the polymeric matrix or that facilitates the formation of the blend or composite of the polymeric matrix and the cellulosic material, such that the blend or composite has improved properties compared to a similar blend or composite that does not include the coupling agent.

“Masterbatch” as used herein means a formulation in which there is a high concentration of additives that is used to portion additives accurately into a larger bulk of a composition.

One hour half-life information for various organic peroxides can be found in Luperox® Organic Peroxides/High Polymers catalog by Arkema (Colombes Cedex), and incorporated herein in its entirety for all purposes. Organic peroxides with a one hour half-life below 98° C. can be acceptable for the use disclosed herein only if the peroxides exhibit no significant loss of peroxide assay at that same temperature for least one month. The half-life time is the time at which 50% of the peroxide has decomposed at a specified temperature, and the half-life temperature is the temperature at which 50% of the peroxide has decomposed at a specified time, as described in “SAFETY AND HANDLING OF ORGANIC PEROXIDES: A Guide Prepared by the Organic Peroxide Producers Safety Division of Plastics Industry Association”, Plastics Industry Association, Inc., OPPSD Bulletin AS-109 (August 2018), incorporated herein in its entirety for all purposes.

Reducing the water content of wood flour or sawdust, or other cellulosic material used as the filler in these composites is important. Certain cellulosic materials, for example, wood flour may have 4 wt % to 6 wt % or higher moisture content (water). Preferably the cellulosic material after drying has a water content below 4 wt %, preferably around 3 wt %, more preferably around 2 wt %, more preferably a 1 wt % moisture content, even more preferably around 0.5 wt % or lower.

If wood flour is used as the cellulosic material, its particle size typically ranges from 80 to 40 mesh (180-425 μm). Use of particle sizes outside this typical range can also be considered, e.g., up to 20 mesh (850 μm or 0.85 mm diameter). If used, the type of wood flour and/or sawdust used in the practice of this invention may be sourced from various hard wood type timber taken from deciduous trees that have broad leaves, and soft wood timber taken from conifer or cone-bearing trees.

Disclosed herein is a coupling agent formulation and masterbatch comprising, consisting of, or consisting essentially of at least one zinc-containing reagent and/or at least one silicon-containing reagent. In particular, the inventors have discovered a coupling agent composition for cellulosic material-polymer composites, wherein at least one zinc-containing reagent and/or at least one silicon containing reagent are blended with at least one room temperature organic peroxide which may or may not be functionalized, or an organic peroxide formulation comprising at least one or more room temperature organic peroxides which may or may not be functionalized, or a combination thereof.

Importantly, the coupling agent formulations disclosed herein may comprise, consist of or consist essentially of the at least one zinc-containing reagent and the at least one organic peroxide. The coupling agent formulations may comprise, consist of or consist essentially of the at least one silicon-containing reagent and the at least one organic peroxide. The coupling agent formulations disclosed herein may comprise, consist of or consist essentially of the at least one zinc-containing reagent, the at least one silicon-containing reagent and the at least one organic peroxide. Combinations of zinc-containing reagents, combinations of silicon-containing reagents, and combinations of organic peroxides are also contemplated.

Zinc-Containing Reagents:

Surprisingly, these zinc-containing reagents were effective when used with the organic peroxides as a coupling agent, with or without the silicon-containing reagents. The zinc-containing reagents used in the practice of this invention may comprise: zinc acrylates and methacrylates; zinc species that have Zn—O functionality; zinc alkoxides; zinc carboxylates; zinc (acetylacetonates); zinc formate; or zinc oxide. Also suitable are zinc-containing reagents that have at least one substituent including at least one carbon-carbon double bond reactive to free radicals, including zinc acrylates and methacrylates. Other zinc-containing reagents that are suitable to use in embodiments of this invention include: zinc halides, zinc dithiodicarbamates, zinc sulfonate, zinc hydrates, zinc tetrahydrofuran adducts, or zinc N,N,N′,N′-tetramethylethylenediamine adducts; or combinations thereof. Non-limiting specific examples of suitable zinc-containing reagents are zinc diacrylate; zinc dimethacrylate; zinc monoacrylate; zinc monomethacrylate; zinc methoxide; zinc ethoxide; zinc isopropoxide; zinc methoxyethoxide; zinc bis(acetate); zinc bis(2-ethylhexanoate); zinc bis(neodecaonate); zinc bis(cyclohexanebutyrate); zinc naphthenate; zinc undecylenate; oxo[hexa(trifluoroacetato)]tetrazinc; zinc bis(2,2,6,6-tetramethyl-3,5-heptanedionato); zinc bis (hexafluoroacetylacetonate; zinc formate; zinc oxide; zinc dimethyldithiocarbamate; zinc diethyldithiocarbamate; dibutyldithiocarbamate; zinc chloride, zinc bromide, zinc fluoride, zinc iodide; zinc sulfonate; zinc carbonate; zinc nitrate; zinc hydrates; zinc tetrahydrofuran adducts; zinc N,N,N′,N′-tetramethylethylenediamine adducts; or combinations thereof.

Preferred are zinc diacrylate; zinc dimethacrylate; zinc monoacrylate; zinc monomethacrylate; zinc methoxide; zinc ethoxide; zinc isopropoxide; zinc methoxyethoxide; zinc bis(acetate); zinc bis(2-ethylhexanoate); zinc bis(neodecaonate); zinc bis(cyclohexanebutyrate); zinc naphthenate; zinc undecylenate; oxo[hexa(trifluoroacetato)]tetrazinc; zinc bis(2,2,6,6-tetramethyl-3,5-heptanedionato); zinc bis (hexafluoroacetylacetonate; zinc formate; zinc oxide; zinc dimethyldithiocarbamate; zinc diethyldithiocarbamate; dibutyldithiocarbamate; or combinations thereof. More preferred are: zinc diacrylate; zinc dimethacrylate; zinc monoacrylate; zinc monomethacrylate; or combinations thereof. Even more preferred are zinc diacrylate; zinc dimethacrylate; or combinations thereof.

Silicon-Containing Reagents:

Surprisingly, the silicon-containing reagents were found to provide an improved cellulosic material-polymer composite when used with the organic peroxides with or without the presence of the zinc-containing reagents. The at least one silicon-containing reagents have structure (I):

SiR¹R²R³R⁴ (I).

At least one of R¹, R², R³, or R⁴ comprises, consists of or consists essentially of at least one unsaturation and the remaining R¹, R², R³, or R⁴ are hydrogen or alkyl or alkoxy groups and may be the same or different.

Non-limiting examples of the silicon-containing reagents are unsaturated silicon-containing species; vinyl(alkoxy)silanes; vinyl(alkyl)silanes; poly(vinyl)silanes; (vinyl)(alkyl)(alkoxy)silanes; vinyl-terminated polydimethylsiloxanes; allylsilanes; vinylsilanes; Specific compounds may include vinyl triethoxysilane; vinyl trimethoxysilane, vinyl triisopropoxysilane, vinyl tri-t-butoxysilane; vinyl tris(2-methoxyethoxy)silane; vinyl triacetoxysilane; trivinyl methoxysilane; trivinyl ethoxysilane; trivinyl isopropoxysilane divinyldimethoxysilane; divinyldiethyoxysilane; vinyltrimethylsilane; vinyltriethylsilane; vinyltriisopropylsilane; vinyltributylsilane; divinyldimethylsilane; divinyl silane; trivinyl silane; tetravinylsilane; vinyldimethylethoxysilane; vinylmethyldiethoxysilane; 1,3-divinyltetramethyldisiloxane; 1,3,5-trivinyl-1,3,5-trimethylcyclotrisiloxane; 1,3,5,7-tetravinyl-1,3,5,7-tetramethylcyclotetrasiloxane; vinylmethylbis(trimethylsiloxy)silane; 1,1,3,3-tetravinyldimethyldisiloxane; tetravinyldimethyldisiloxane; 1,4-divinyl-1,1,4,4-tetramethyl-1,4-disilabutane; methylbis(trimethylsilyloxy)vinylsilane; 2-(dimethylvinylsilyl)pyridine; tris(2-methoxyethoxy)(vinyl)silane; triacetoxy(vinyl)silane; tris(trimethylsiloxy)(vinyl)silane; 1-cyclopenten-1-yl(trimethyl)silane; trimethyl[(1Z)-1-propyl-1-butenyl]silane; (5,5-dimethyl-1-cyclopententen-1-yl)(trimethyl)silane; trimethyl(6-methyl-1-cyclohexen-1-yl)silane; (4-methoxy-1-cyclohexen-1-yl)(trimethyl)silane; trimethyl(4-methyl-1,5-cyclohexadien-1-yl)silane; trimethyl(5-methyl-1,5-cyclohexadien-1-yl)silane; (6,6-dimethyl-1-cyclohexen-1-yl)(trimethyl)silane; allyl(methyl)1-naphthyl(phenyl)silane; trimethyl(1-phenyl-2-propenyl)silane; 2-cycloocten-1-yl(trimethyl)silane; trimethyl [(2E)-3-phenyl-2-propenyl]silane; trimethyl[2-[(trimethylsilyl)methyl]-2-propenyl]silane; trimethyl(3-phenyl-2-cyclohexen-1-yl)silane; tert-butyldimethyl(2-propynyloxy)silane; dimethyl-di(methacroyloxy-1-ethoxy)silane; trimethoxy(7-octen-1-yl)silane; trimethyl(2,3,4,5-tetramethyl-2,4-cyclopentadien-1-yl)silane; (2-methyl-allyl)-triphenyl-silane; (1-hydroxy-allyl)-tri-methyl-silane; (3-methyl-3-butenyl)(triphenyl)silane; 1-cyclododecen-1-yl(methyl)silane; 1-cyclohepten-1-yl(trimethyl)silane; [2-(cyclohexylmethyl)-2-propenyl](trimethyl)silane; 2-yuclohexen-1-yl(trimethyl)silane; bis(pentafluorophenyl)methyl(alpha-stytyl)silane; tert-butyl(dimethyl)[(2E)-2,4-pentadienyloxy]silane; or combinations thereof.

Preferred compounds are vinyl triethoxysilane; vinyl trimethoxysilane, vinyl triisopropoxysilane, vinyl tri-t-butoxysilane; vinyl tris(2-methoxyethoxy)silane; vinyl triacetoxysilane; trivinyl methoxysilane; trivinyl ethoxysilane; trivinyl isopropoxysilane divinyldimethoxysilane; divinyldiethyoxysilane; vinyltrimethylsilane; vinyltriethylsilane; vinyltriisopropylsilane; vinyltributylsilane; divinyldimethylsilane; or combinations thereof. More preferred are vinyl triethoxysilane; vinyl trimethoxysilane, vinyl triisopropoxysilane, vinyl tri-t-butoxysilane; or combinations thereof. Even more preferred are vinyl triethoxysilane; vinyl trimethoxysilane; or combinations thereof.

Combinations of two or more of these unsaturated silane reagents may be used.

Optionally, at least one saturated silane compound may also be used in combination with these saturated silane species. In a less preferred embodiment, the saturated silane compounds may also be included with the zinc-containing reagent, in an embodiment that does not include the unsaturated silanes having structure (I). These saturated silanes may have the following structure (II):

SiR⁵R⁶R⁷R⁸ (II).

In structure (II), R⁵, R⁶, R⁷, or R⁸ do not comprise, consist of or consist essentially of an unsaturation and are hydrogen or alkyl or alkoxy groups and may be the same or different from each other and may be the same or different from the R¹, R², R³, or R⁴ groups that do not contain an unsaturation in structure (I).

Non-limiting examples of the saturated silane reagent of structure (II) are tetra(alkoxy)silanes and (alkyl)(alkoxy)silanes. Non-limiting specific compounds are tetramethoxysilane, tetraethoxysilane, tetraisopropoxysilane, and tetrabutoxysilane; methyl tris(methoxy)silane; methyl tris(ethoxy)silane; methyl tris(isopropoxy)silane; ethyl tris(methoxy)silane; ethyl tris(ethoxysilane); ethyl tris(isopropoxy)silane; propyltris(methoxy)silane; propyl tris(ethoxysilane); propyl tris(isopropoxy)silane; or combinations thereof. If present, preferred are tetramethoxysilane, tetraethoxysilane; methyl tris(methoxy)silane; methyl tris(ethoxy)silane; methyl tris(isopropoxy)silane; ethyl tris(methoxy)silane; ethyl tris(ethoxysilane); ethyl tris(isopropoxy)silane; or combinations thereof. More preferred are tetramethoxysilane, tetraethoxysilane; methyl tris(methoxy)silane; methyl tris(ethoxy)silane; ethyl tris(methoxy)silane; ethyl tris(ethoxysilane); ethyl tris(isopropoxy)silane; or combinations thereof. Even more preferred are tetramethoxysilane, tetraethoxysilane; methyl tris(methoxy)silane; or combinations thereof.

Boron Compounds in Combination with Silicon-Containing Reagents of Formula (I):

Optionally, if the coupling agent formulation comprises, consists of or consists essentially of the at least one silicon-containing reagent of formula (I) it may advantageously further comprise, consist of or consist essentially of at least one borate or borate salt or boric acid reagent.

Non-limiting examples are boric acid, sodium tetraborate decahydrate, sodium tetraborate pentahydrate, sodium tetraborate anhydrous, disodium octaborate tetrahydrate, disodium octaborate anhydrous, sodium metaborate, calcium borate, zinc borate, ammonium borate, or combinations thereof. Boric acid is preferred.

If present, the weight ratio of the boric acid or borate salt to the silicon-based reagent of structure (I) is from 10:1 to 1:10, or from 2:1 to 1:8, or from 1:1 to 1:6 or from 1:3 to 1:5 or 1:3.5 to 1:4.5.

Organic Peroxides:

The organic peroxide may comprise high boiling non-aromatic compounds such as mineral spirits or mineral oil that serve as safety diluents. The organic peroxide formulation may also contain sorbitan monooleate, sorbitan dioleate, polysorbate 80, polypropylene glycol, or mixtures thereof.

The organic peroxides may be liquid or solid organic peroxides but must be stable (retain their efficacy) at 20° C. for at least one month, preferably for at least three months. Both t-amyl peroxy and t-butyl peroxy type peroxides may be useful in certain embodiments of the present disclosure. In particular, the preferred organic peroxides are those with a 1 hour or longer half-life above 98° C. One hour half-life information for various organic peroxides can be found in Luperox® Organic Peroxides/High Polymers catalog published by Arkema (Colombes Cedex), the entire contents of which are incorporated by reference herein for all purposes. The half-life of the organic peroxides at 98° C. may be determined from dilute solution kinetics by direct peroxide analysis by either gas or liquid chromatography as appropriate for the peroxide class or type. The solid organic peroxides and solid functionalized organic peroxides may exhibit ambient 20° C. stability so as not to lose any significant % assay in at least one month, preferably three months, as directly determined by either titration, gas chromatography or liquid chromatography depending upon the peroxide class.

In some embodiments, an organic peroxide formulation may contain at least one stabilizer, for example but not limited to at least one quinone type compound or at least one nitroxide type compound or a combination of these. In some embodiments, the peroxide formulation containing at least one quinone compound or at least one nitroxide compound or combination; may also contain at least one allylic or more preferably a diallyl compound, even more preferably a triallyl compound to serve as an allylic coagent.

In some instances, a functionalized organic peroxide may be selected from those room temperature stable peroxides (i.e., having at least 1 hour half-life at 98° C. that possess carboxylic acid, one or more double bonds capable of reacting with a free radical, methoxy or hydroxy functionality. A non-limiting example of a suitable functionalized peroxides is t-butylperoxy maleic acid available under the name Luperox® PNP-25 from Arkema. This carboxylic acid functionalized organic peroxide can be used in blends with the various additives disclosed herein including acids such as itaconic acid, its anhydride and/or its allyl esters. The coupling agent formulation may further comprise a carrier such as, but not limited to, particulate cellulosic materials, particulate organic or inorganic materials, such as but not limited to particulate polymers, silicas, clays, dried wood flour, dried saw dust, cellulose acetate butyrate powder, to create a novel coupling agent masterbatch. These carriers are discussed on more detail below.

Suitable organic peroxides suitable for use in the practice of some embodiments of this invention may be selected from room temperature stable organic peroxides. The organic peroxide may be in liquid form, solid form, solid flake, solid powder form that is extended on inert filler, meltable solid form, or a pourable paste form. These various peroxide forms may be used in the coupling agent compositions disclosed herein. Suitable organic peroxides may be capable of decomposing and forming reactive free radicals when exposed to a source of heat, for example in an extruder.

The organic peroxide suitable for use in certain embodiments of the zinc-containing reagent and/or silicon-containing reagent coupling agent composition for cellulosic material-polymer composites may be selected from those room temperature stable peroxides that possess carboxylic acid, methoxy or hydroxy functionality. “Room-temperature stable” in the context of this disclosure means an organic peroxide that has not decomposed, i.e., has retained its assay, after at least three months at 20° C. Room temperature stable organic peroxides in the context of this disclosure may be defined as having a half-life of at least 1 hour at 98° C. An exception to this rule applies to the diacyl solid peroxides: non-limiting examples such as dibenzoyl peroxide; 2, 4-dichlorobenzoyl peroxide; or para-methyl dibenzoyl peroxide which are thermally stable at ambient 20° C. temperatures but have a half-life shorter than 1 hour 98° C.

Non-limiting examples of suitable organic peroxides classes are diacyl peroxides, peroxyesters, monoperoxycarbonates, peroxyketals, hemi-peroxyketals, solid at ambient temperature (20° C.) peroxydicarbonates, and dialkyl peroxide classes are suitable, as are the t-butylperoxy and t-amylperoxy classes. In addition, cyclic organic peroxides, for example: Trigonox® 301 and Trigonox® 311 peroxides from Nouryon are contemplated. Suitable peroxides may be found in “Organic Peroxides” by Jose Sanchez and Terry N. Myers; Kirk Othmer Encyclopedia of Chemical Technology, Fourth Ed., Volume 18, (1996), the disclosure of which is incorporated herein by reference in its entirety for all purposes. Thermally stable functionalized peroxides with carboxylic acid, hydroxyl and/or possessing a free radical reactive unsaturated group are also suitable. The organic peroxide may contain mineral spirits, mineral oil, or a food-grade white mineral oil to serve as safety diluents.

The organic peroxide may also be extended on inert fillers (e.g., wood flour, saw dust, bamboo flour, straw, straw flour, rice hulls, wheat straw, hemp, flax, peanut shell flour, scrap paper, scrap cardboard, Burgess clay, kaolin clay, calcium carbonate, silica, fumed silica, precipitated silica, gypsum, calcium silicate, and cellulose acetate butyrate, for example) or used in powder or pellet form as a peroxide masterbatch on EPDM (ethylene propylene diene monomer rubber), EPM (ethylene propylene rubber) PE (polyethylene), HDPE (high density polyethylene) PP (polypropylene), microcrystalline wax, polycaprolactone) wherein the peroxide concentration could vary from 1 wt % to 80 wt %, preferably from 0.1 wt % to 60 wt %, more preferably from 0.1 wt % to 40 wt % depending upon the application.

Non-limiting examples of suitable organic peroxides are: di-t-butyl peroxide; t-butyl cumyl peroxide; t-amyl cumyl peroxide; dicumyl peroxide; 2,5-di(cumylperoxy)-2,5-dimethyl hexane; 2,5-di(cumylperoxy)-2,5-dimethyl hexyne-3; 4-methyl-4-(t-butylperoxy)-2-pentanol; 4-methyl-4-(t-amylperoxy)-2-pentanol; 4-methyl-4-(cumylperoxy)-2-pentanol; 4-methyl-4-(t-butylperoxy)-2-pentanone; 4-methyl-4-(t-amylperoxy)-2-pentanone; 4-methyl-4-(cumylperoxy)-2-pentanone; 2,5-dimethyl-2,5-di(t-butylperoxy)hexane; 2,5-dimethyl-2,5-di(t-amylperoxy)hexane; 2,5-dimethyl-2,5-di(t-butylperoxy)hexyne-3; 2,5-dimethyl-2,5-di(t-amylperoxy)hexyne-3; 2,5-dimethyl-2-t-butylperoxy-5-hydroperoxy hexane; 2,5-dimethyl-2-cumylperoxy-5-hydroperoxy hexane; 2,5-dimethyl-2-t-amylperoxy-5-hydroperoxy hexane; m/p-alpha, alpha-di(t-butylperoxy)diisopropyl benzene; meta-di(t-butylperoxy)diisopropyl benzene; para-di(t-butylperoxy)diisopropyl benzene; 1,3,5-tris(t-butylperoxyisopropyl)benzene; 1,3,5-tris(t-amylperoxyisopropyl)benzene; 1,3,5-tris(cumylperoxyisopropyl)benzene; di [1,3-dimethyl-3-(t-butylperoxy)butyl] carbonate; di [1,3-dimethyl-3-(t-amylperoxy)butyl] carbonate; di [1,3-dimethyl-3-(cumylperoxy)butyl] carbonate; di-t-amyl peroxide; t-amyl cumyl peroxide; t-butylperoxy-isopropenylcumylperoxide; t-amylperoxy-isopropenylcumylperoxide; 2,4-diallyloxy-6-tert-butyl peroxide-1,3,5-trazine; 2,4-diallyloxy-6-tert-amyl peroxide-1,3,5-trazine; 2,4,6-tri(butylperoxy)-s-triazine; 1,3,5-tri [1-(t-butylperoxy)-1-methylethyl] benzene; 1,3,5-tri-[(t-butylperoxy)-isopropyl benzene; 1,3-dimethyl-3-(t-butylperoxy)butanol; 1,3-dimethyl-3-(t-amylperoxy)butanol; and mixtures thereof. Illustrative solid, room temperature stable peroxy dicarbonates include, but are not limited to: di(2-phenoxyethyl)peroxydicarbonate; di(4-t-butyl-cyclohexyl)peroxydicarbonate; dimyristyl peroxydicarbonate; dibenzyl peroxydicarbonate; and di(isobornyl)peroxydicarbonate. Solid diacyl peroxides include: dibenzoyl peroxide; 2,4-dichlorobenzoyl peroxides; and di(methylbenzoyl)peroxide.

Other dialkyl type organic peroxides which may be used singly or in combination with the other organic peroxides contemplated by the present disclosure are those selected from the group represented by the formula:

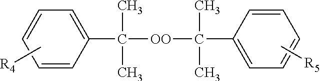

wherein R₄ and R₅ may independently be in the meta or para positions and are the same or different and are selected from hydrogen or straight or branched chain alkyls of 1 to 6 carbon atoms. Dicumyl peroxide and isopropylcumyl cumyl peroxide are illustrative.

Other dialkyl peroxides may include but are not limited to: 3-cumylperoxy-1,3-dimethylbutyl methacrylate; 3-t-butylperoxy-1,3-dimethylbutyl methacrylate; 3-t-amylperoxy-1,3-dimethylbutyl methacrylate; tri(1,3-dimethyl-3-t-butylperoxy butyloxy)vinyl silane; 1,3-dimethyl-3-(t-butylperoxy)butyl N-[1-{3-(1-methylethenyl)-phenyl}1-methylethyl]carbamate; 1,3-dimethyl-3-(t-amylperoxy)butyl N-[1-{3-(1-methylethenyl)-phenyl}-1-methylethyl]carbamate; 1,3-dimethyl-3-(cumylperoxy))butyl N-[1-{3-(1-methylethenyl)-phenyl}-1-methylethyl]carbamate.

Other variants of dialkyl type peroxides which contain two different peroxide groups of varying chemical and/or thermal reactivity may be included in this invention. Non-limiting examples include: 25-dimethyl-(2-hydroperoxy-5-t-butylperoxy)hexane and 2,5-dimethyl-(2-hydroperoxy-5-t-amylperoxy)hexane.

In the group of diperoxyketal type organic peroxides, suitable compounds may include: 1,1-di(t-butylperoxy)-3,3,5-trimethylcyclohexane; 1,1-di(t-amylperoxy)-3,3,5-trimethylcyclohexane; 1,1-di(t-butylperoxy)cyclohexane; 1,1-di(t-amylperoxy)cyclohexane; n-butyl 4,4-di(t-amylperoxy)valerate; ethyl 3,3-di(t-butylperoxy)butyrate; 2,2-di(t-amylperoxy)propane; 3,6,6,9,9-pentamethyl-3-ethoxycabonylmethyl-1,2,4,5-tetraoxacyclononane; n-butyl-4,4-bis(t-butylperoxy)valerate; ethyl-3,3-di(t-amylperoxy)butyrate;

and mixtures thereof.

Other organic peroxides that may be used according to at least one embodiment of the present disclosure include benzoyl peroxide, OO-t-butyl-O-hydrogen-monoperoxy-succinate and OO-t-amyl-O-hydrogen-monoperoxy-succinate.

Illustrative cyclic ketone peroxides are compounds having the general formulae (I), (II) and/or (III).

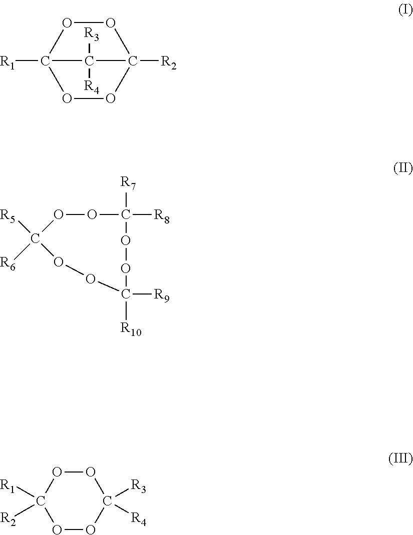

wherein R₁ to R₁₀ are independently selected from the group consisting of hydrogen, C1 to C20 alkyl, C3 to C20 cycloalkyl, C6 to C20 aryl, C7 to C20 aralkyl and C7 to C20 alkaryl, which groups may include linear or branched alkyl properties and each of R1 to R10 may be substituted with one or more groups selected from hydroxy, C1 to C20 alkoxy, linear or branched C1 to C20 alkyl, C6 to C20 aryloxy, halogen, ester, carboxy, nitride and amido.

Some non-limiting examples of suitable cyclic ketone peroxides include but are not limited to: 3,6,9, triethyl-3,6,9-trimethyl-1,4,7-triperoxynonane (or methyl ethyl ketone peroxide cyclic trimer), methyl ethyl ketone peroxide cyclic dimer, and 3,3,6,6,9,9-hexamethyl-1,2,4,5-tetraoxacyclononane.

Non-limiting illustrative examples of peroxy esters include: 2,5-dimethyl-2,5-di(benzoylperoxy)hexane; t-butylperbenzoate; t-butylperoxyacetate; t-butylperoxy-2-ethyl hexanoate; t-amylperbenzoate; t-amyl peroxy acetate; t-butyl peroxy isobutyrate; 3-hydroxy-1,1-dimethyl t-butyl peroxy-2-ethyl hexanoate; OO-t-amyl-O-hydrogen-monoperoxy succinate; OO-t-butyl-O-hydrogen-monoperoxy succinate; di-t-butyl diperoxyphthalate; t-butylperoxy (3,3,5-trimethylhexanoate); 1,4-bis(t-butylperoxycarbo)cyclohexane; t-butylperoxy-3,5,5-trimethylhexanoate; t-butyl-peroxy-(cis-3-carboxy)propionate; allyl 3-methyl-3-t-butylperoxy butyrate. Illustrative monoperoxy carbonates include: OO-t-butyl-O-isopropylmonoperoxy carbonate; OO-t-amyl-O-isopropylmonoperoxy carbonate; OO-t-butyl-O-(2-ethyl hexyl)monoperoxy carbonate; OO-t-amyl-O-(2-ethyl hexyl)monoperoxy carbonate; 1,1,1-tris[2-(t-butylperoxy-carbonyloxy)ethoxymethyl]propane; 1,1,1-tris[2-(t-amylperoxy-carbonyloxy)ethoxymethyl]propane; 1,1,1-tris[2-(cumylperoxy-carbonyloxy)ethoxymethyl]propane; OO-t-amyl-O-isopropylmonoperoxy carbonate.

Other peroxides that may be used according to at least one embodiment of the present disclosure include the functionalized peroxyester type peroxides: OO-t-butyl-O-hydrogen-monoperoxy-succinate; OO-t-amyl-O-hydrogen-monoperoxysuccinate; OO-t-amylperoxymaleic acid and OO-t-butylperoxymaleic acid.

Also suitable in the practice of this invention is an organic peroxide branched oligomer comprising at least three peroxide groups comprises a compound represented by structure below:

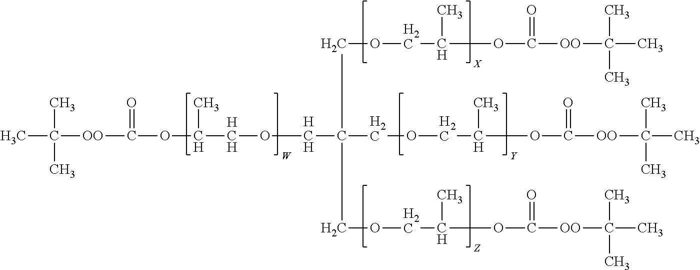

wherein the sum of W, X, Y and Z is 6 or 7. One example of this type of uniquely branched organic peroxide is the tetrafunctional polyether tetrakis(t-butylperoxycarbonate). An example of this type of peroxide is Luperox® JWEB50 (Arkema).

Illustrative hemi-peroxyketal class of organic peroxides include: 1-methoxy-1-t-amylperoxycyclohexane; 1-methoxy-1-t-butylperoxycyclohexane; 1-methoxy-1-t-amylperoxy-3,3,5 trimethylcyclohexane; 1-methoxy-1-t-butylperoxy-3,3,5 trimethylcyclohexane. An example of this type of peroxide is Luperox® V10 (Arkema) which is 93% assay 1-methoxy-1,1-dimethyl propyl peroxycyclohexane.

Illustrative diacyl peroxides include but are not limited to: di(4-methylbenzoyl)peroxide; di(3-methylbenzoyl)peroxide; di(2-methylbenzoyl)peroxide; didecanoyl peroxide; dilauroyl peroxide; 2,4-dibromo-benzoyl peroxide; succinic acid peroxide; dibenzoyl peroxide; di(2,4-dichloro-benzoyl)peroxide. Imido peroxides of the type described in PCT Application publication WO9703961 A1 are also contemplated as suitable for use and incorporated by reference herein for all purposes.

Functionalized organic peroxides are suitable for use in the zinc-containing reagent and/or silicon-containing reagent coupling agent formulation for cellulosic material-polymer composites. A non-limiting example of a functionalized organic peroxide is t-butylperoxy maleic acid. Non-limiting examples of a functionalized peroxide are t-butylperoxy maleic acid; t-amylperoxy maleic acid; t-butylperoxy-isopropenylcumylperoxide; t-amylperoxy-isopropenylcumylperoxide; 4-methyl-4-(t-butylperoxy)-2-pentanol; 4-methyl-4-(t-amylperoxy)-2-pentanol; 4-methyl-4-(cumylperoxy)-2-pentanol; 2,5-dimethyl-(2-hydroperoxy-5-t-butylperoxy)hexane and 2,5-dimethyl-(2-hydroperoxy-5-t-amylperoxy)hexane; 2,4-diallyloxy-6-tert-butyl peroxide-1,3,5-trazine; 2,4-diallyloxy-6-tert-amyl peroxide-1,3,5-trazine; and mixtures thereof. Preferred organic peroxides include: t-butylperoxymaleic acid; 1-methoxy-1-t-amylperoxycyclohexane; dilauryl peroxide; t-butylperoxy-2-ethylhexanoate; 1,1-di(t-butylperoxy)-3,3,5-trimethylcyclohexane; 1,1-di(t-amylperoxy)cyclohexane; 1,1-di(t-butylperoxy)cyclohexane; t-butylperoxy-3,5,5-trimethylhexanonate; t-amylperoxyacetate; t-butylperoxyacetate; t-amylperbenzoate; t-butylperbenzoate; OO-t-butyl-O-isopropylmonoperoxy carbonate; OO-t-amyl-O-isopropylmonoperoxy carbonate; OO-t-butyl-O-(2-ethyl hexyl)monoperoxy carbonate; OO-t-amyl-O-(2-ethyl hexyl)monoperoxy carbonate; dicumyl peroxide; Luperox® JWEB-50, a polyether poly-t-butylperoxycarbonate (Arkema); Luperox® 313, a complex mixture of peroxides and containing <15 wt % t-butyl cumyl peroxide (Arkema); Luperox® D-68, a complex mixture of dicumyl peroxide, di-t-butylperoxydiisopropylbenzene and t-butyl cumyl peroxide (Arkema); Luperox® D-446-B, a complex mixture of di-t-butylperoxydiisopropylbenzene and t-butyl cumyl peroxide (Arkema); t-butyl cumyl peroxide; t-butylperoxy-isopropenylcumylperoxide; m/p-di-t-butylperoxydiisopropylbenzene) and mixtures thereof.

More preferred peroxides are: t-butylperoxymaleic acid; 1-methoxy-1-t-amylperoxycyclohexane; dilauryl peroxide; t-butylperoxy-2-ethylhexanoate; 1,1-di(t-butylperoxy)-3,3,5-trimethylcyclohexane; 1,1-di(t-amylperoxy)cyclohexane; 1,1-di(t-butylperoxy)cyclohexane; t-butylperoxy-3,5,5-trimethylhexanonate; t-amylperoxyacetate; t-butylperoxyacetate; t-amylperbenzoate; t-butylperbenzoate; OO-t-butyl-O-isopropylmonoperoxy carbonate; OO-t-amyl-O-isopropylmonoperoxy carbonate; OO-t-butyl-O-(2-ethyl hexyl)monoperoxy carbonate; OO-t-amyl-O-(2-ethyl hexyl)monoperoxy carbonate; dicumyl peroxide; Luperox® 313, a complex mixture of peroxides and containing <15 wt % t-butyl cumyl peroxide (Arkema); Luperox® D-68, a complex mixture of dicumyl peroxide, di-t-butylperoxydiisopropylbenzene and t-butyl cumyl peroxide (Arkema); t-butylperoxy-isopropenylcumylperoxide; m/p-di-t-butylperoxydiisopropylbenzene) and mixtures thereof.

Even more preferred are: t-butylperoxymaleic acid; t-butylperoxy-2-ethylhexanoate; 1,1-di(t-butylperoxy)-3,3,5-trimethylcyclohexane; 1,1-di(t-amylperoxy)cyclohexane; 1,1-di(t-butylperoxy)cyclohexane; t-butylperoxy-3,5,5-trimethylhexanonate; t-amylperbenzoate; t-butylperbenzoate; OO-t-butyl-O-isopropylmonoperoxy carbonate; OO-t-amyl-O-isopropylmonoperoxy carbonate; OO-t-butyl-O-(2-ethyl hexyl)monoperoxy carbonate; Luperox® 313, a complex mixture of peroxides and containing <15 wt % t-butyl cumyl peroxideArkema); Luperox® D-68, a complex mixture of dicumyl peroxide, di-t-butylperoxydiisopropylbenzene and t-butyl cumyl peroxide (Arkema); t-butylperoxy-isopropenylcumylperoxide; m/p-di-t-butylperoxydiisopropylbenzene, bis(tert-butyldioxyisopropyl)benzene (VulCup®) and mixtures thereof.

Amounts of the Zinc-Containing Reagent and/or the Silicon-Containing Reagent and the Organic Peroxide in the Coupling Agent Formulation for Cellulosic Material-Polymer Composites:

In some embodiments the coupling agent formulation for cellulosic material-polymer composites may comprise from 1% to 99% by total weight of the formulation of the organic peroxide and from 99% to 1% by weight of the zinc-containing reagent and/or the silicon-containing reagent.

According to particular embodiments, the at least one organic peroxide may be included in the coupling agent formulation for cellulosic material-polymer composites in an amount from 1 wt % to 95 wt %, or from 5 wt % to 95 wt % 10 wt % to 90 wt %, or from 20 wt % to 99 wt %, or from 30 wt % to 90 wt % or from 40 wt % to 75 wt %, or from 40 wt % to 70 wt %, or from 40 wt % to 65 wt %, or from 45 wt % to 80 wt %, or from 45 wt % to 75 wt %, or from 45 wt % to 70 wt %, or from 45 wt % to 65 wt %, or from 50 wt % to 98 wt %, or from 50 wt % to 75 wt %, or from 50 wt % to 70 wt %, or from 50 wt % to 65 wt %, from 50 wt % to 60 wt %, from 1 wt % to 50 wt %; or from 1 wt % to 40 wt %; or from 1 wt % to 25 wt % based on the total formulation.

According to particular embodiments, the zinc-containing reagent and/or the silicon-containing reagent may be included in the coupling agent formulation for cellulosic material-polymer composites in an amount from 95 wt % to 5 wt %, or from 90 wt % to 10 wt %, or from 99 wt % to 20 wt %, or from 90 wt % to 30 wt % or from 75 wt % to 40 wt %, or from 70 wt % to 40 wt %, or from 65 wt % to 40 wt %, or from 80 wt % to 45 wt %, or from 75 wt % to 45 wt %, or from 70 wt % to 40 wt %, or from 65 wt % to 45 wt %, or from 98 wt % to 50 wt %, or from 75 wt % to 50 wt %, or from 70 wt % to 50 wt %, or from 65 wt % to 50 wt %, from 60 wt % to 50 wt %, based on the total weight of the coupling agent formulation for cellulosic material-polymer composites.

The ratio by weight of the organic peroxide to the zinc-containing reagent and/or the silicon-containing reagent may be from 1:1000 to 1000:1 or from 1:100 to 100:1, or from 1:9 to 9:1 or from 4:5 to 5:4 or from 1:5 to 5:1 or from 1:1 to 1:2 or from 2:1 to 3:1 or from 1:9 to 1:1 or from 1:1 to 9:1 or from 2:1 to 1:1. Organic peroxide to zinc-containing reagent and/or the silicon-containing reagent ratio may be 1:40 to 1:1; 1:20 to 1:1; 1:10 to 1:1; 1:5 to 1:1; or 1:3 to 1:1.

The ratio by weight of the zinc-containing reagent and/or the silicon-containing reagent to the organic peroxide may be 2:0.4. A typical cellulosic material-polymer composite may comprise, consist of or consist essentially of 40-85 wt % cellulosic material; 60-15% polymer and 1 to 5 wt % of the coupling agent formulation. A composite may include 45-75 wt %, 40-65 wt % or 45-60 wt % of the cellulosic material. A composite may include 50-25 wt %, 45-30 wt % or 40-30 wt % of the polymer. A composite may include 1-4 wt % or 2-4 wt % of the coupling agent formulation.

Polymeric Matrix Materials for Cellulosic Material-Polymer Composites:

Suitable polymeric matrix materials for the cellulosic material-polymer composites include but are not limited to LLDPE (linear low density polyethylene), HDPE (high density polyethylene), MDPE (medium density polymethylene) and/or LDPE (low density polyethylene). Recycled polymers are also suitable. All preferably have a high melt flow index (MFI) of <40 g/10 min; preferably <20 g/10 min; more preferably <10 g/10 min; more preferably <5 g/10; even more preferred <1 g/10 min, most preferably <0.5 g/10 min at 190° C. with a 2.15 kg load as described in test method ASTM 01238. The polyethylenes used in this invention are preferably high molecular weight wherein the molecular weight for the polyethylene grades start at roughly 50,000 g/mole to 200,000 up to about 250,000 g/mole for the types of PE comprising LDPE, LLDPE, MDPE (medium density polyethylene) and HDPE or blends thereof from virgin or recycled sources. Ultrahigh molecular weight polyethylene (UHWMPE) may also be present having molecular weight from 3,000,000 g/mole to 7,500,000 g/mole. Other polymers are also suitable, for example, polypropylene, acrylics, polyvinyl chloride, polystyrenes, in combination with the polyethylenes.

Also contemplated are recycled polymers such as polyolefins, especially polyethylene (for example HDPE, LLDPE, MDPE and LDPE). However low cost ground solid polymer particulates from mixed recycled polymer waste streams may be considered for some embodiments where cost is a concern. As is known in the art, polyethylene derived from plastic waste streams may comprise, in addition to the polyethylene, other polymers, for example, polystyrene, polyethylene terephthalate, polypropylene, scrap paper/cardboard.

Cellulosic Materials:

Wood and wood products are commonly used as the cellulosic component in cellulosic material-polymer composites. Wood flour is a common cellulosic filler used in cellulosic material-polymer composite deck boards, fencing and siding. Wood flour is finely pulverized wood that has a consistency similar to sand or sawdust, but can vary considerably, with particles ranging in dimensions from a fine powder to roughly that of a grain of rice. Most wood flour manufacturers are able to create batches of wood flour that have the same consistency throughout. All high quality wood flour is made from hardwoods because of its durability and strength. Very low grade wood flour is occasionally made from sapless softwoods such as pine or fir. However, there is always a search for better and/or more economical, lower cost fillers to replace wood flour. These other natural fillers that can be considered in the practice of our invention comprise rice hull powder, straw powder or fibers e.g., wheat straw; bamboo fiber, flax, jute, hemp, cellulose, ground wood, saw dust, palm fiber, bagasse, peanut shells, chitin, and kenaf fibers. Scrap paper and cardboard may also be used in embodiments of the present disclosure, either alone or in combination with wood flour or sawdust. The wood flour may be produced from soft wood, hard wood or a blend. Typically, the lignin is removed from the wood flour, but this may be optional.

Sawdust or wood shavings may also be suitable for use as the filler in cellulosic material-polymer composites in certain embodiments of the present disclosure. Sawdust (or wood shavings) may be a by-product or waste product and is composed of fine particles of wood.

Another relatively low cost filler considered in the practice of this invention is ground recycled truck and/or passenger tires. Worn tires may be ground into a powder useful in this invention. The amount of the ground tire may be 50 wt % to 1 wt % of the composite.

One embodiment of this invention is the use of this ground recycled rubber tire filler together with wood flour or other cellulosic material filler, polyethylene and at least one coupling agent and at least one organic peroxide. Other fillers that may be used in combination with wood flour/wood saw dust (or other cellulosic material) in some embodiments include chlorinated polyethylene powder and chlorosulfonated polyethylene powder. Cellulose acetate butyrate (CAB) may be used in certain embodiments as a filler. The preferred CAB grade will have an upper melting point no higher than 160° C., preferably no higher than 150° C., even more preferred no higher than 145° C. and most preferred less than 143° C. The most preferred grades of CAB that may be included as a filler have a butyryl content of approximately 52%. Non-limiting examples are: Eastman Chemical Cellulose Acetate Butyrate (CAB-551-0.2) and (CAB-551-0.01).

Improved Properties:

Properties of the cellulosic material-polymer composite that may be improved or changed due to the inclusion of the zinc-containing reagent and/or silicon-containing reagent coupling agent formulation for cellulosic material-polymer composites may include but are not limited to: improved compatibility between the polymer matrix and the cellulosic filler, reduced water absorption, improved stiffness, improved impact resistance, improved compatibility with other polymers, improved compatibility with fillers and allowing the increased use of lower cost ground recycled materials e.g., paper, cardboard, scrap rugs, tires, polyethylene plastic bags/bottles and recycled PET containers, for example. The use of recycled materials provides a useful product while reducing a waste stream.

For example, the cellulosic material-polymer composite including the coupling agent formulation as disclosed herein may also improve compatibility of polymer blends, such that the polymer matrix may comprise a polyethylene and another polymer. Non-limiting examples of other such polymers are polyacrylates and copolymers of polyacrylates. Elium® resin (Arkema) may be considered. Also contemplated in small amounts (<2 wt % to <1 wt % of the entire formulation) are fluoropolymers such as polyvinylidene difluoride (PVDF e.g. Kynar® (Arkema)) and polytetrafluoroethylene (PTFE). The coupling agents disclosed herein for cellulosic material-polymer composites disclosed herein may be more compatible with fillers or extenders or strengthening agents, or impact modifiers than such composites not including the zinc-containing-reagent and/or silicon-containing reagent coupling agent formulation for cellulosic material-polymer composites. Cellulose acetate butyrate (CAB) may be used as a filler.

The coupling agent formulation for cellulosic material-polymer composites may be in the form of a solid or a liquid, depending on the form of the organic peroxide and the form of the zinc-containing and/or silicon-containing reagent. The zinc-containing and/or silicon-containing coupling agent formulation for cellulosic material-polymer composites may be in the form of a masterbatch formulation.

Masterbatch:

A coupling agent masterbatch for cellulosic material-polymer composites is provided. The coupling agent masterbatch for cellulosic material-polymer composites may comprise, consist of, or consist essentially of a) at least one organic peroxide; b) at least one of i) at least one zinc-containing reagent; and/or ii) at least one silicon-containing reagent; and

c) at least one carrier for the coupling agent masterbatch.
The ii) at least one silicon-containing reagent has structure (I):

SiR¹R²R³R⁴ (I).

In structure (I), at least one of R¹, R², R³, or R⁴ comprises, consists of or consists essentially of at least one unsaturation and the remaining R¹, R², R³, or R⁴ are hydrogen or alkyl or alkoxy groups and may be the same or different

The at least one organic peroxide and the at least one zinc-containing reagent; and the at least one silicon-containing reagent are described above.

As is known in the art, a masterbatch is a concentrated combination of the coupling agent formulation for cellulosic material-polymer composites that is added to a polymer matrix and cellulosic material filler that are processed (compounded) into the finished article, such as a deck board, siding or fencing.

Carriers for the Coupling Agent Masterbatch

These coupling agent formulations may be extended on fillers or blends of fillers to provide a free-flowing powder product or masterbatch. Non-limiting examples of such fillers comprise calcium carbonate, Burgess Clay, fumed silica, kaolin clay, precipitated silica, microcellulose, cellulose acetate butyrate (CAB), calcium silicate, silica, fly ash, perlite, talc, magnesium hydroxide, gypsum, silica, dried wood flour, dried saw dust, dried straw particles/flour, or mixtures thereof. Preferred are: Burgess Clay, precipitated calcium carbonate, precipitated silica, calcium silicate, microcellulose, dried wood flour, dried sawdust, cellulose acetate butyrate, and mixtures thereof. Most preferred are: Burgess clay, precipitated silica, calcium silicate, dried wood flour, dried sawdust and mixtures thereof.

The carrier for the coupling agent masterbatch for cellulosic material-polymer composites may comprise, consist of, or consist essentially of one or more of the polymer and or cellulosic material filler components of the final cellulosic material-polymer composite. For example, the coupling agent formulation comprising the organic peroxide and the zinc-containing reagent and/or the silane reagent of formula (I) as described above may be combined with wood flour, sawdust, polyethylene, calcium carbonate, synthetic calcium silicate, Burgess Clay, kaolin clay, fumed silica, precipitated silica, microcellulose, fly ash, talc, magnesium hydroxide, gypsum, dried wood flour, dried saw dust; dried straw particles, perlite, calcium silicate, and combinations thereof. In some embodiments, particulate materials as the carrier may be preferred, since the masterbatch may be prepared by blending a formulation of the organic peroxide and the zinc and/or silane reagents with the particulate material to form a free-flowing, non-caking, particulate masterbatch.

Other non-limiting examples of suitable particulate carrier materials for the masterbatch are dried saw dust, dried wood flour, bamboo flour, hemp flour, scrap paper, scrap cardboard, cellulose acetate butyrate, and combinations thereof. Also suitable are inert carriers, for example silica, fumed silica, precipitated silica, talc, calcium carbonate, clay, Burgess clay, kaolin, fly ash.

In another embodiment, the carrier material may comprise, consist of, or consist essentially of a low-melting wax, for example. The organic peroxide and zinc and/or silicon-containing reagents may be melt-blended with the wax, and then the resulting masterbatch pelleted. Only small amounts of these waxes are contemplated, such that the final cellulosic material-polymer composite material comprises less than 5 wt % of the low melting wax. Suitable waxes include, but are not limited to bio-based waxes, such as beeswax, soy wax, bayberry wax, candelilla wax, carnauba wax, castor wax, vegetable wax, ouricury wax, rice bran wax, lanolin, and the like. Others may include the known non-bio-based petroleum based waxes.

According to an embodiment, the coupling agent formulation as disclosed herein may be melt-blended with a polymeric carrier and formed into granules or pellets. Non-limiting examples of suitable polymers are those that are suitable for use as the matrix for the cellulosic material-polymer composite, e.g., polyolefins and copolymers thereof, polyethylene, polypropylene, acrylics, polyvinyl chloride, polystyrenes, or combinations thereof.

The concentration of the organic peroxide and the zinc reagent and/or silicon-containing reagent of Formula (I) and optionally other additives disclosed herein, combined together in the masterbatch as wt % of the masterbatch may be varied as necessary depending on the let-down and the desired concentration of the coupling agent formulation the final cellulosic material-polymer composite. Non-limiting examples of suitable concentrations in the masterbatch may range from 40-65 wt %, or from 30-75 wt %, or from 50-70 wt %, or from 40-50 wt % of the organic peroxide and the zinc reagent and/or silicon-containing reagent of structure (I), but the range may be from 1 wt % to 80 wt % or from 2 wt % to 60 wt % or from 5 wt % to 50 wt % or from 10 wt to 40 wt % depending upon the peroxide(s), zinc-containing reagent, silicon-containing reagent and other additives chosen for the masterbatch blend.

Stabilizers for the Organic Peroxide:

The coupling agent formulation for cellulosic material-polymer composites may comprise, consist of, or consist essentially of stabilizers for the organic peroxide, for example at least one quinone type compound. In some instances, if the at least one quinone compound is used as stabilizer for the organic peroxide, at least one allylic compound, preferably a triallyl compound may also be included with organic peroxide. Non-limiting examples of the allylic compounds are TAC (triallyl cyanurate), TAIC (triallylisocyanurate), triallyl trimellitate, diallyl maleate, diallyl tartrate, diallyl phthalate, diallyl carbonate, allylphenylether, allylmethacrylate and the higher molecular weight allylmethacrylate oligomers sold by Sartomer.

In some embodiments, at least one stabilizer or free radical trap may be selected from the group consisting of nitroxides (e.g., 4-hydroxy-TEMPO) and quinones, such as mono-tert-butylhydroquinone (MTBHQ). These stabilizers may be referred to as free radical traps (i.e., any agent that interacts with free radicals and inactivates them) and any such agent as known to those of ordinary skill in the art can be employed in the practice of this invention. Hindered phenols as a stabilizer many be considered like olive leaf oil (oleuropein), or Irganox® 1076 or Irganox® 1010. Vitamin K1, K2 and K3 are also part of this group. As used herein, the term “quinone” includes both quinones and hydroquinones. Non-limiting examples of quinones that may be used in formulations of the present invention include mono-tert-butylhydroquinone (MTBHQ), hydroquinone, hydroquinone mono-methyl ether (HQMME) (also known as 4-methoxy phenol), mono-t-amylhydroquinone, hydroquinone bis(2-hydroxyethyl) ether, 4-ethoxy phenol, 4-phenoxy phenol, 4-(benzyloxy) phenol, 2,5-bis (morpholinomethyl) hydroquinone, and benzoquinone.

Methods of Producing the Coupling Agent Masterbatch:

A method of producing a coupling agent masterbatch for cellulosic material-polymer composites is provided. The method may comprise, consist of, or consist essentially of, the steps A) and B).
Step A) may comprise, consist of, or consist essentially of combining: a) at least one organic peroxide, and b) at least one of i) at least one zinc-containing reagent; and/or ii) at least one silicon-containing reagent having structure (I):

SiR¹R²R³R⁴ (I);
wherein at least one of R¹, R², R³, or R⁴ comprises, at least one unsaturation and the remaining R¹, R², R³, or R⁴ are hydrogen or alkyl or alkoxy groups and may be the same or different; and
c) optionally at least one silicon-containing reagent having structure (II):

SiR⁵R⁶R⁷R⁸ (II);
wherein R⁵, R⁶, R⁷, or R⁸ do not comprise an unsaturation and are hydrogen or alkyl or alkoxy groups and may be the same or different from each other and may be the same or different from the R¹, R², R³, or R⁴ groups that do not contain an unsaturation;
to form a coupling agent formulation for cellulosic material-polymer composites.

The a) organic peroxide may have a half-life of at least one hour at 98° C.

Optional additives may be selected from the group consisting of coagents; sulfur containing compounds and/or elemental sulfur; and mixtures thereof. Other optional additives are boric acid or borate salts. Other additives as are commonly known and used in the art may also be included, such as but not limited to stabilizers for the polymers and stabilizers for the peroxides.

Step B) may comprise, consist of, or consist essentially of combining the coupling agent formulation for cellulosic material-polymer composites with c) at least one carrier to form the coupling agent masterbatch for cellulosic material-polymer composites.

According to certain embodiments of the disclosure, the coupling agent formulation for cellulosic material-polymer composites may be in the form of a liquid and the at least one carrier may be in the form of solid particulates. Suitable solid particulates that may be used in certain embodiments are: calcium carbonate, Burgess Clay, precipitated silica, microcellulose, fly ash, dried wood flour, dried saw dust, dried straw particles, recycled ground paper scrap, recycled ground/shredded cardboard scrap, recycled ground rug fiber scrap, recycled ground passenger/truck tires, and combinations thereof. The solid particulates may those as described above. In certain embodiments of the invention, the step B) may comprise mixing a liquid coupling agent formulation with the at least one carrier in the form of solid particulates to form the coupling agent masterbatch, such that the coupling agent masterbatch may be in the form of solid particulates at 25° C. The coupling agent masterbatch thus may be in the form of free-flowing solid particulates.

According to another embodiment, the steps A) and B) may be performed at the same time, i.e., the at least one organic peroxide, the at least zinc-containing reagent and/or the at least one silicon-containing reagent and the at least one carrier material may be mixed together simultaneously. For example, the steps A) and B) may done in a low shear ribbon type blender, e.g., a Marion® type ribbon blender to form a coupling agent masterbatch including the particulates mentioned above to form a masterbatch. It is also possible to conduct the blending of the various components in a high shear Henschel® type blender to create a free flowing powder masterbatch.

The at least one organic peroxide may be selected from those as recited above or mixtures thereof. The at least one zinc-containing reagent and/or the at least one silicon-containing reagent may be selected from those recited above or combinations thereof.

The combining step B) may comprise melt blending the various ingredients into a polymer. The melt blending may be conducted for example, in single-screw extrusion, twin-screw extrusion, ZSK mixer, Banbury mixer, Buss kneader, two-roll mill, or impeller mixing, or other type of suitable polymer melt blending equipment to produce the coupling agent masterbatch. The blending time and temperature conditions for the combining step B) may be selected such that the organic peroxide used does not decompose more than 4 wt %, preferably less than 2 wt % more preferably less than 1 wt %.

Methods of Producing the Cellulosic Material-Polymer Composites:

A method of producing a cellulosic material-polymer composite is provided. The method comprises, consists of, or consists essentially of, a step I) of combining components A), B) and C) to form a component mixture. Components A), B) and C) comprise, consist of, or consist essentially of, the following: A) comprises, consists of, or consists essentially of, the coupling agent for the cellulosic material-polymer composite as disclosed herein. B) comprises, consists of, or consists essentially of, a polymer matrix for a cellulosic material-polymer composite as disclosed above. C) comprises, consists of, or consists essentially of, at least one cellulosic filler selected from those described above. The method also comprises, consists of, or consists essentially of, a step II) of forming the component mixture into a composite.

An alternate method of producing a cellulosic material-polymer composite is also provided. This alternate method is similar to the first method, but the alternate method comprises, consists of, or consists essentially of, using a coupling agent masterbatch. In particular, a step I) of combining components A), B) and C) to form a component mixture. Components A), B) and C) comprise consists of, or consist essentially of, the following: A) comprises, consists of, or consists essentially of, a coupling agent masterbatch for the cellulosic material-polymer composites as disclosed herein. B) comprises, consists of, or consists essentially of, a polymer matrix for a cellulosic material-polymer composite as disclosed above. C) comprises, consists of, or consists essentially of, at least one cellulosic filler selected from those described above. This alternate method also comprises, consists of, or consists essentially of, a step II) of forming the component mixture into a composite.

In both of these methods of forming the cellulosic material-polymer composite, the combining step I) may be for example combining the components A) polymer matrix, C) the cellulosic filler and B) either the zinc-containing reagent and/or silicon-containing reagent coupling agent formulation or the coupling agent masterbatch in the feed to an extruder. For example the components may be metered directed into a hopper of an extruder, such that the feed section of the extruder provides much of the combining step. The combining step may comprise dry-mixing the components, such as in a drum tumbler, or ribbon blender, or high shear blender and then feeding the dry mix to the hopper of the extruder. If the coupling agent formulation or the coupling agent masterbatch is in the form of a liquid, the liquid may be metered separately into the feed of the extruder, and the polymer matrix and the filler may be either directly combined into the extruder hopper, or separately dry-mixed. Other such methods as are known in the art and may be used in some embodiments. For example the components may be combined using melt blending, for example, in single-screw extrusion, twin-screw extrusion, ZSK mixer, Banbury mixer, Buss kneader, two-roll mill, or impeller mixing, or other type of suitable polymer melt blending equipment to produce the reaction mixture. The combining step may be a part of process to produce finished article, for example a extrusion through a die to form a solid cellulosic material-polymer composite board, or using a roll mill to create a sheet for use in thermoforming processes, or using blown film process, or compression molding process to create various parts. Other processes known in the art including injection molding, injection blow molding, thermoforming, or vacuum forming may be performed to create finished goods in some embodiments.

The forming step II) in either method of forming the composite may be for example extruding the component mixture through a die affixed to an extruder. The forming step may be a step of thermoforming, for example, using a set of heated dies. Other forming methods contemplated include injection molding, calendaring, blow molding, foaming, injection blow molding, vacuum forming, compression molding, and thermoforming. The composite may be polymer lumber, for example a deck board intended to be used in outdoor environments. Other useful article of manufacture include but are not limited to cladding, siding, outdoor furniture, exterior decking, interior flooring, indoor furniture, pallets, floors, railings, fences, siding, molding, trim, window frames, door frames, landscaping timber, industrial cribbing, marine walls and pilings, boat slips, and wall paneling.

Other Additives:

Fillers and/or stabilizers for the peroxides may also be included in the coupling agent formulation for cellulosic material-polymer composites. For example calcium carbonate, talc, silica, fumed silica, precipitated silica, calcium carbonate, calcium silicate, diatomaceous earth, clay, Burgess clay, kaolin, fly ash, powdered polyethylene, or ground/powdered recycled passenger or truck tires, ground/powdered recycled rug fibers, ground recycled mixed polymer streams that may include small amounts of various polymers including polypropylene or poly(ethylene propylene) copolymer or poly(ethylene octene) copolymer or LDPE, or HDPE, or LLDPE; chopped fiberglass, ground paper, ground cardboard and/or ground scrap particle board may be used.

Other additives may be included to the cellulosic material-polymer composite formulation that are known to one of skill in the art, may include for example: colorants, mildew inhibitors, insecticides, other fillers besides wood flour, antioxidants, light/UV stabilizers, blowing or foaming agents, polymer flow aids, extrusion slip aids such as erucic acid amide, non-metal type lubricants such as ethylene bisstearimide; Glycolube™ WP2200 from Lonza; Struktol® TPW 113 and Struktol® TPW 617 are non-limiting examples; fungcides (such as Folpet® from Zeneca Ag Products and Bethoxazin®); process aids, mold release agents, antioxidants, anti-blocking agents, and the like. Suitable mold release agents known in the art include fatty acids, zinc, calcium and magnesium salts of fatty acids. Mold release and slip agents may be added in an amount less than about 5 wt % based on the total weight of the final cellulosic material-polymer composite.

The zinc-containing reagent and/or silicon-containing reagent coupling agent formulation may further comprise at least one sulfur containing compound to serve as a co-curing agent. Non-limiting examples of these co-curing agents are: disulfides, elemental sulfur, and sulfur-containing amino acids. The Vanderbilt Rubber Handbook, thirteenth edition, 1990, R.T. Vanderbilt Company, Inc., publisher, the entire disclosure of which is incorporated by reference herein for all purposes, lists many types of sulfur containing compounds used for curing rubber. Non-limiting examples include monosulfides, 2-mercaptobenzothiazole (MBT), 2-2′-dithiobis(benzothiazole) (MBTS), disulfides, diallyldisulfide, polysulfides and the arylpolysulfide compounds such as the amylphenol polysulfides e.g. VULTAC® (Arkema). Specific examples include Vultac® 5, Vultac® 3, Vultac® 7, mercaptobenzothiazole disulfide (MBTS) and zinc dialkyldithiophosphate (ZDDP). Also included as co-curing agents are sulfur containing amino acid compounds, for example cysteine, methionine, homocysteine, taurine, n-formyl methionine and s-adenosylhomocysteine. The organic peroxide formulation may contain at least one sulfur containing compound, in particular at least one disulfide containing compound or elemental sulfur or a combination as a co-curing agent.

The zinc-containing reagent and/or silicon-containing reagent coupling agent formulation may also further comprise a coagent which may work in concert with the at least one organic peroxide. Importantly, these coagents are different from the zinc-containing reagent and the silicon-containing reagent that are part of the coupling agent formulation. A crosslinking coagent has a function that is different from a peroxide: without wishing to be bound by theory, a coagent may be capable of being activated with the aid of a free radical initiator such as organic peroxides. Thus activated during the decomposition of the peroxide, it may then form crosslinking bridges with the polymer and is therefore may be integrated into the chain of the crosslinked polymer, unlike peroxides. Non-limiting examples of suitable coagents include allyl, acrylic, methacrylic and styrenic containing compounds, different from the zinc-containing reagents disclosed herein. Monoallyl, diallyl and triallyl compounds may be considered. Non-limiting examples include: allylphenylether, epoxidized allylphenylether, allylmethacrylate monomers and oligomers (as sold by Sartomer), diallylmaleate, diallyldisulfide, diallyl itaconate, diallyl tartrate, diallyl phthalate, trimethylolpropane diallylether triallyltrimellitate, triallylcyanurate, partially epoxidized triallyl cyanurate, triallylisocyanurate, partially epoxidized triallylisocyanurate, and trimethylolpropane triallylether. Other non-limiting examples of such coagents are: alpha-methylstyrene dimer, or poly(methyl methacrylate) dissolved in methyl methacrylate monomer (available under the name Elium® from Arkema). Use of Elium® resin with at least one organic peroxide formulation is contemplated in this disclosure. Elium® may also be used in combination with the other components disclosed herein.

Mixtures of any or all of these additives are contemplated.

Excluded from certain embodiments of this invention are “stand oils” made by polymerizing natural or bio-based oils. Polyester resins and those made using the various acids listed in the disclosure herein. Other exclusions from certain embodiments are water, added as a separate component to the formulation in amounts of about 5% about 4%, about 3%, about 2%, about 1% about 0.5% wt % or about 1000 ppm wt. Hydrogen peroxide is excluded. Inorganic peroxides are excluded. The intentional incorporation of water or the use of additives diluted with significant amounts of water is not desired in the practice of this invention. AIBN (azobisisobutyronitrile) or azo initiators are excluded. Any or all of these compounds may be present in the coupling agent formulation for cellulosic material-polymer composites at levels of not more than to 5 wt %, 4 wt %, 3 wt %, 2 wt %, for wt %, based on the total weight of the organic peroxide and the zinc-containing reagent and/or the silicon-containing reagent. Preferably, none of these compounds are present in the formulation.

Standard Test Methods and Equipment Used in the Practice of this Invention

Standard Guide for Evaluating Mechanical and Physical Properties of Wood-Plastic Composite Products ASTM D7031-11 (2019). This ASTM standard guide discloses test methods appropriate for evaluating a wide range of performance properties for cellulosic material-polymer composites such as wood-polymer composite (WPC) products.

The following test methods are used: ASTM D6109-19 (2019) Test Methods for Flexural Properties of Unreinforced and Reinforced Plastic Lumber and Related Products; ASTM D6341-98 (1998) Test Method for Determination of the Linear Coefficient of Thermal Expansion of Plastic Lumber and Plastic Lumber Shapes Between 30° F. and 140 F (34.4° C. and 60° C.); ASTM D4442-16 (2016) Test Methods for Direct Moisture Content Measurement of Wood and Wood-Based Materials; ASTM D4761-19 (2019) Test Methods for Mechanical Properties of Lumber and Wood-Based Structural Materials (e.g. modulus of rupture: MOR); ASTM D1238-13 (2013) Standard Test Method for Melt Flow Rates of Thermoplastics by Extrusion Plastometer (used to determine polyethylene Melt Flow Index-MFI); ASTM D5289-19a (2019) Standard Test Method for Rubber Property-Vulcanization Using Rotorless Cure Meters (can be used for polyethylene); and ASTM D4440-15 (2015) Standard Test Method for Plastics: Dynamic Mechanical Properties Melt Rheology.

Non-limiting aspects of this disclosure may be summarized below:

### EXAMPLES

Sample Mixing Procedures

Wood flour (40M1 Hardwood 40 mesh wood flour, American Wood Fibers), was placed in a stainless steel pan in a vented oven and heated for 22-24 hours at 110° C. The dried wood flour, high density polyethylene, talc, zinc stearate, N,N′-ethylene bisstearamide, and other ingredients (including peroxide and additives) were weighed on an open-air balance and charged to a 1-gallon polyethylene bag (total mass of material for mixing=approximately 230 grams), the bag sealed, and bag shaken by hand (approximately 30 seconds) to provide initial mixing. The contents of the bag were then transferred to an internal mixer (Brabender Intelli Torque Plasticorder, 3 pieces, 350 cc Prep Mixer bowl, banbury blades, WinMix software) and mixed at 150° C. and 50 RPM until a stable torque measurement was reached. Material was backed out from and then added back to the mixing bowl, and mixed for a total of three minutes (50 RPM, 150° C.). Following subsequent removal of material from the bowl, final compounding was conducted using a press (Carver 15 ton model 3893; 10 seconds at 10 ksi and 150° C.).

Plaque Preparation Procedures

Onto a 8″×8″×0.108″ stainless steel plate was placed a thinner metal sheet (8″×8″×0.035″), on top of which was placed a 8″×8″×0.016 mm sheet of aluminum foil. On top of the aluminum foil was placed a 8″×8″×0.125″ stainless steel plaque frame with inner cavity dimensions 6″×6″. Into the cavity of the plaque frame was placed approximately 90 grams of compounded wood plastic composite material, which was then covered with a layer of aluminum foil, a thin metal sheet, and a stainless steel plate. The entire plaque assembly was subjected to 15 Kpsi pressure for 13 minutes at 185° C. (Wabash Genesis 30 Ton G30H press). The plaque frame and sample were removed from the press and allowed to cool to ≤35° C. Once cool, rectangular (4″×0.5″) strips of pressed material were cut (using a bandsaw) from the plaques for flexural testing.

Physical Property Testing Procedures

Three-point flexural testing was conducted according to ASTM D790, using an Instron 33R 4204 incorporating a 2″ span, a 500N static load cell, and a flex rate of 0.5 in/minute. Reported values of Modulus of Rupture (MOR) and Modulus of Elasticity (MOE) are average values obtained from measurement of between three and five samples cut from each test plaque, with outliers (defined as exhibiting >5% deviation from the remaining measurements' average) excluded from calculation.

Results are shown below:

| | Comp. Ex. 1 | Comp. Ex. 2 | Ex. 1 | Ex. 2 | Ex. 3 | Ex. 4 | Ex. 5 | Ex. 6 |
|---|---|---|---|---|---|---|---|---|
| Wood flour | 57 | 57 | 57 | 57 | 57 | 57 | 57 | 57 |
| High density | 32 | 32 | 32 | 32 | 32 | 32 | 32 | 32 |
| polyethylene | | | | | | | | |
| Talc | 6 | 5 | 5 | 3 | 5 | 0 | 0 | 0 |
| Zinc stearate | 2 | 2 | 2 | 2 | 2 | 2 | 2 | 2 |
| Ethylene bisstearamide | 1 | 1 | 1 | 1 | 1 | 1 | 1 | 1 |
| Novacom-P ™ | 2 | 2 | | | | | | |
| HFS2100P** | | | | | | | | |
| Vinyl | | | 2 | 4 | 1 | 4 | 3 | 3 |
| triethoxysilane | | | | | | | | |
| Tetraethoxysilane | | | | | 1 | 3 | 3 | 3 |
| Magnesium sulfate | | | | | | | 1 | |
| Boric acid | | | | | | | | 1 |
| Vul-Cup ® 40KE | | 1 | 1 | 1 | 1 | 1 | 1 | 1 |
| Modulus of | 3681 | 4266 ± 288* | 5574 | 6794 | 5410 | 7641 | 7546 | 7791 |
| Rupture (psi) | | | | | | | | |
| Modulus of | 499 | 472 ± 3* | 491 | 454 | 480 | 481 | 505 | 481 |
| Elasticity (ksi) | | | | | | | | |

**Maleic anhydride (MAH) grafted high density polyethylene (HPDE) polymer in a powder form.
*These are the average and standard deviation of data from three runs of identical composition.

| | Example | Example | Example | Example | Example | Example |
|---|---|---|---|---|---|---|
| | 7 | 8 | 9 | 10 | 11 | 12 |
| Wood flour | 57 | 57 | 57 | 57 | 57 | 57 |
| High density | 32 | 32 | 32 | 32 | 32 | 32 |
| polyethylene | | | | | | |
| Talc | 5 | 3 | 0 | 3 | 0 | 0 |
| Zinc stearate | 2 | 2 | 2 | 2 | 2 | 2 |
| Ethylene bisstearamide | 1 | 1 | 1 | 1 | 1 | 1 |
| Zinc diacrylate | 2 | 4 | 4 | | | |
| Zinc dimethacrylate | | | | 4 | 4 | 4 |
| Potassium aluminum sulfate | | | 3 | | 3 | |
| Aluminum hydroxide | | | | | | 3 |
| Vul-Cup ® 40KE | 1 | 1 | 1 | 1 | 1 | 1 |
| Modulus of Rupture (psi) | 5946 | 7309 | 8301 | 6773 | 7314 | 7792 |
| Modulus of Elasticity (ksi) | 503 | 473 | 579 | 548 | 613 | 526 |

Examples 5-6 show that additives of the current invention will work in conjunction with bio-based additives (including but not limited to magnesium sulfate, magnesium oxide, borax, and boric acid).

The extruded wood polymer board samples of Example 1 and Example 2 made using the coupling agents of this invention are tested using the methods described in the detailed description. All boards have improved physical properties compared to wood polymer composite boards with no coupling agent and as compared to comparative samples made with maleic anhydride. The improvement in modulus of the samples made with the inventive coupling agent formulation is especially important in reducing the effect of creep in fencing and siding and other applications that are sensitive to creep.

### Prophetic Example 1: Improved Creep with Inventive Coupling Agent

A compounded wood-plastic composite made with additives of the invention, produced as described above, is subjected to creep testing as described in ASTM D2990-17 and ASTM D6112-18. The creep of the composite made with additives of the invention is significantly less than composites made without coupling agents or compatibilizing additives. The creep of the composite made with additives of the invention is significantly less than composites made incorporating maleic anhydride grafted polymer as the coupling agent.

### Prophetic Example 2: Extrusion of a Cellulosic Material-Polymer Composite

Dried wood flour, high density polyethylene, talc, zinc stearate, N,N′-ethylene bisstearamide, and other ingredients of the present invention (including peroxide and additives) are dry mixed using a ribbon blender and then charged to a gravity hopper connected to a co-rotating twin screw extruder. In the twin screw extruder, the ingredients are heated and mixed, and then passed through a heated profile die. Following extrusion from the die, the profile is cooled in a cooling tank and cut into lengths appropriate for various applications (such as decking, siding, or physical property testing). The profiles made with the inventive coupling agent formulation has significantly improved physical properties relative to those made either without coupling agents or that incorporated maleic anhydride grafted polymer as the coupling agent. Physical properties include mechanical strength (rupture resistance and stiffness), water absorption, impact resistance, and creep. Similar results are obtained when using a masterbatch of the coupling agent to incorporate the coupling agent into the composite article.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to produce the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A coupling agent formulation for cellulosic material-polymer composites comprising:
a) at least one organic peroxide; and
b) at least one of i) at least one zinc-containing reagent; and/or ii) at least one silicon-containing reagent having structure (I):
SiR¹R²R³R⁴ (I);
wherein at least one of R¹, R², R³, or R⁴ comprises at least one unsaturation and the remaining R¹, R², R³, or R⁴ are hydrogen or alkyl or alkoxy groups and may be the same or different.

2. The coupling agent formulation of claim 1, further comprising:
c) at least one silicon-containing reagent having structure (II):
SiR⁵R⁶R⁷R⁸ (II);
wherein R⁵, R⁶, R⁷, or R⁸ do not comprise an unsaturation and are hydrogen or alkyl or alkoxy groups and may be the same or different from each other and may be the same or different from the R¹, R², R³, or R⁴ groups that do not contain an unsaturation.

3. The coupling agent formulation of claim 1, comprising the at least one silicon-containing reagent of formula (I) and further comprising at least one of boric acid, sodium tetraborate decahydrate, sodium tetraborate pentahydrate, sodium tetraborate anhydrous, disodium octaborate tetrahydrate, disodium octaborate anhydrous, sodium metaborate, calcium borate, zinc borate, ammonium borate, or combinations thereof.

4. The coupling agent formulation of claim 1, wherein the at least one zinc-containing reagent comprises at least one of:
an organic zinc compound comprising Zn—O functionality;
an organic zinc compound comprising Zn—O functionality and at least one polymerizable substituent;
an organic zinc compound comprising Zn—O functionality and at least one unsaturation;
a non-organic zinc oxide or hydrate thereof;
a zinc halide; or
combinations thereof.

5. The coupling agent formulation of claim 1, wherein the at least one silicon-containing reagent having structure (I) comprises at least one of vinyl(alkoxy)silanes; vinyl trimethoxysilane, vinyltriethoxysilane, vinyl triisopropoxysilane, vinyl tri-t-butoxysilane; vinyl tris(2-methoxyethoxy)silane; vinyl triacetoxysilane; trivinyl methoxysilane; trivinyl ethoxysilane; trivinyl isopropoxysilane divinyldimethoxysilane; divinyldiethyoxysilane; vinyl(alkyl)silanes; vinyltrimethylsilane; vinyltriethylsilane; vinyltriisopropylsilane; vinyltributylsilane; divinyldimethylsilane; poly(vinyl) silanes; divinyl silane; trivinyl silane; tetravinylsilane; (vinyl)(alkyl)(alkoxy)silanes; vinyldimethylethoxysilane; vinylmethyldiethoxysilane; 1,3-divinyltetramethyldisiloxane; 1,3,5-trivinyl-1,3,5-trimethylcyclotrisiloxane; 1,3,5,7-tetravinyl-1,3,5,7-tetramethylcyclotetrasiloxane; vinylmethylbis(trimethylsiloxy)silane; 1,1,3,3-tetravinyldimethyldisiloxanetetravinyldimethyldisiloxane; vinyl-terminated polydimethylsiloxanes; 1,4-divinyl-1,1,4,4-tetramethyl-1,4-disilabutane; methylbis(trimethylsilyloxy)vinylsilane; 2-(dimethylvinylsilyl)pyridine; tris(2-methoxyethoxy)(vinyl)silane; triacetoxy(vinyl)silane; tris(trimethylsiloxy)(vinyl)silane; 1-cyclopenten-1-yl(trimethyl)silane; trimethyl[(1Z)-1-propyl-1-butenyl]silane; (5,5-dimethyl-1-cyclopententen-1-yl)(trimethyl)silane; trimethyl(6-methyl-1-cyclohexen-1-yl)silane; (4-methoxy-1-cyclohexen-1-yl)(trimethyl)silane; trimethyl(4-methyl-1,5-cyclohexadien-1-yl)silane; trimethyl(5-methyl-1,5-cyclohexadien-1-yl)silane; (6,6-dimethyl-1-cyclohexen-1-yl)(trimethyl)silane; allyl(methyl)1-naphthyl(phenyl)silane; trimethyl(1-phenyl-2-propenyl)silane; 2-cycloocten-1-yl(trimethyl)silane; trimethyl [(2E)-3-phenyl-2-propenyl]silane; trimethyl[2-[(trimethylsilyl)methyl]-2-propenyl]silane; trimethyl(3-phenyl-2-cyclohexen-1-yl)silane; tert-butyldimethyl(2-propynyloxy)silane; dimethyl-di(methacroyloxy-1-ethoxy)silane; trimethoxy(7-octen-1-yl)silane; trimethyl(2,3,4,5-tetramethyl-2,4-cyclopentadien-1-yl)silane; (2-methyl-allyl)-triphenyl-silane; (1-hydroxy-allyl)-tri-methyl-silane; (3-methyl-3-butenyl)(triphenyl)silane; 1-cyclododecen-1-yl(methyl)silane; 1-cyclohepten-1-yl(trimethyl)silane; [2-(cyclohexylmethyl)-2-propenyl](trimethyl)silane; 2-yuclohexen-1-yl(trimethyl)silane; bis(pentafluorophenyl)methyl(alpha-stytyl)silane; tert-butyl(dimethyl)[(2E)-2,4-pentadienyloxy]silane; or combinations thereof.

6. The coupling agent formulation of claim 2, wherein the at least one silicon-containing reagent having structure (II) comprises at least one of tetra(alkoxy)silanes; tetramethoxysilane; tetraethoxysilane; tetraisopropoxysilane; tetrabutoxysilane; (alkyl)(alkoxy)silanes; methyl tris(methoxy)silane; methyl tris(ethoxy)silane; methyl tris(isopropoxy)silane; ethyl tris(methoxy)silane; ethyl tris(ethoxysilane); ethyl tris(isopropoxy)silane; propyltris(methoxy)silane; propyl tris(ethoxysilane); propyl tris(isopropoxy)silane; or combinations thereof.

7. The coupling agent formulation of claim 1, wherein the at least one organic peroxide has a half-life of at least one hour at 98° C.

8. The coupling agent formulation of claim 1, wherein the at least one organic peroxide comprises at least one functionalized organic peroxide.

9. The coupling agent formulation of claim 1, wherein the at least one organic peroxide comprises at least one of diacyl peroxides; peroxyesters; monoperoxycarbonates; peroxyketals; dialkyl peroxides; t-butylperoxides; t-amylperoxides; carboxylic acid functionalized peroxides, hydroxyl functionalized peroxides, functionalized peroxides possessing a free radical reactive unsaturated group; 3,6,9-triethyl-3,6,9-trimethyl-1,2,4,5,7,8-hexoxonane, 3,3,5,7,7-pentamethyl-1,2,4-trioxepane, t-butylperoxy maleic acid, or combinations thereof.

10. The coupling agent formulation of claim 1, wherein the at least one zinc-containing reagent comprises at least one of zinc diacrylate; zinc di(meth)acrylate; zinc monoacrylate; zinc monomethacrylate; zinc alkoxide; zinc methoxide; zinc ethoxide; zinc isopropoxide; zinc methoxyethoxide; zinc carboxylate; zinc bis(acetate); zinc bis(2-ethylhexanoate); zinc bis(neodecaonate); zinc bis(cyclohexanebutyrate); zinc naphthenate; zinc undecylenate; oxo[hexa(trifluoroacetato)]tetrazinc; zinc(acetylacetonates); zinc bis(2,2,6,6-tetramethyl-3,5-heptanedionato); zinc bis (hexafluoroacetylacetonate); zinc formate; zinc oxide; zinc dithiodicarbamates; zinc dimethyldithiocarbamate; zinc diethyldithiocarbamate; dibutyldithiocarbamate; zinc halides; zinc chloride, zinc bromide, zinc fluoride, zinc iodide; zinc sulfonate; zinc carbonate; zinc nitrate; zinc hydrates; zinc tetrahydrofuran adducts; N,N,N′,N′-tetramethylethylenediamine adducts; or combinations thereof.

11. A coupling agent masterbatch for cellulosic material-polymer composites comprising:
a) at least one organic peroxide;
b) at least one of i) at least one zinc-containing reagent; and/or ii) at least one silicon-containing reagent having structure (I):
SiR¹R²R³R⁴ (I);
wherein at least one of R¹, R², R³, or R⁴ comprises at least one unsaturation and the remaining R¹, R², R³, or R⁴ are hydrogen or alkyl or alkoxy groups and may be the same or different; and
c) at least one carrier for the coupling agent masterbatch.

12. The coupling agent masterbatch of claim 11, further comprising:
d) at least one silicon-containing reagent having structure (II):
SiR⁵R⁶R⁷R⁸ (II);
wherein R⁵, R⁶, R⁷, or R⁸ do not comprise an unsaturation and are hydrogen or alkyl or alkoxy groups and may be the same or different from each other and may be the same or different from the R¹, R², R³, or R⁴ groups that do not contain an unsaturation.

13. The coupling agent masterbatch of claim 11, wherein the at least one carrier for the coupling agent masterbatch is comprises at least one of polyethylene, polypropylene, acrylics, polyvinyl chloride, polystyrenes, fumed silica, perlite, calcium carbonate, Burgess Clay, clay, kaolin clay, talc, magnesium hydroxide, gypsum, precipitated silica, cellulose acetate butyrate (CAB), microcellulose, fly ash, dried wood flour, dried saw dust, dried straw particles, calcium silicate, silica, or combinations thereof.

14. The coupling agent masterbatch of claim 11, wherein the i) at least one zinc-containing reagent or combination thereof comprises at least one of:
an organic zinc compound comprising Zn—O functionality;
an organic zinc compound comprising Zn—O functionality and at least one polymerizable substituent;
an organic zinc compound comprising Zn—O functionality and at least one unsaturation;
a non-organic zinc oxide or hydrate thereof;
zinc halides; or
combinations thereof.

15. The coupling agent masterbatch of claim 11, wherein the at least one organic peroxide has a half-life of at least one hour at 98° C.

16. The coupling agent masterbatch of claim 11, wherein the at least one organic peroxide comprises at least one functionalized organic peroxide.

17. The coupling agent masterbatch of claim 11, wherein the at least one organic peroxide comprises at least one of diacyl peroxides; peroxyesters; monoperoxycarbonates; peroxyketals; dialkyl peroxides; t-butylperoxides; t-amylperoxides; carboxylic acid functionalized peroxides, hydroxyl functionalized peroxides, functionalized peroxides possessing a free radical reactive unsaturated group; 3,6,9-triethyl-3,6,9-trimethyl-1,2,4,5,7,8-hexoxonane, 3,3,5,7,7-pentamethyl-1,2,4-trioxepane, t-butylperoxy maleic acid, bis(tert-butyldioxyisopropyl)benzene, or combinations thereof.

18. The coupling agent masterbatch of claim 11, wherein the at least one zinc-containing reagent comprises at least one of zinc diacrylate; zinc di(meth)acrylate; zinc monoacrylate; zinc monomethacrylate; zinc alkoxide; zinc methoxide; zinc ethoxide; zinc isopropoxide; zinc methoxyethoxide; zinc carboxylate; zinc bis(acetate); zinc bis(2-ethylhexanoate); zinc bis(neodecaonate); zinc bis(cyclohexanebutyrate); zinc naphthenate; zinc undecylenate; oxo[hexa(trifluoroacetato)]tetrazinc; zinc(acetylacetonates); zinc bis(2,2,6,6-tetramethyl-3,5-heptanedionato); zinc bis (hexafluoroacetylacetonate); zinc formate; zinc oxide; zinc dithiodicarbamates; zinc dimethyldithiocarbamate; zinc diethyldithiocarbamate; dibutyldithiocarbamate; zinc halides; zinc chloride, zinc bromide, zinc fluoride, zinc iodide; zinc sulfonate; zinc carbonate; zinc nitrate; zinc hydrates; zinc tetrahydrofuran adducts; N,N,N′,N′-tetramethylethylenediamine adducts; or combinations thereof.

19. The coupling agent masterbatch of claim 11 wherein the at least one silicon-containing reagent having structure (I) comprises at least one of vinyl(alkoxy)silanes; vinyl trimethoxysilane, vinyl triisopropoxysilane, vinyl tri-t-butoxysilane; vinyl tris(2-methoxyethoxy)silane; vinyl triacetoxysilane; trivinyl methoxysilane; trivinyl ethoxysilane; trivinyl isopropoxysilane divinyldimethoxysilane; divinyldiethyoxysilane; vinyl(alkyl)silanes; vinyltrimethylsilane; vinyltriethylsilane; vinyltriisopropylsilane; vinyltributylsilane; divinyldimethylsilane; poly(vinyl) silanes; divinyl silane; trivinyl silane; tetravinylsilane; (vinyl)(alkyl)(alkoxy)silanes; vinyldimethylethoxysilane; vinylmethyldiethoxysilane; 1,3-divinyltetramethyldisiloxane; 1,3,5-trivinyl-1,3,5-trimethylcyclotrisiloxane; 1,3,5,7-tetravinyl-1,3,5,7-tetramethylcyclotetrasiloxane; vinylmethylbis(trimethylsiloxy)silane; 1,1,3,3-tetravinyldimethyldisiloxanetetravinyldimethyldisiloxane; vinyl-terminated polydimethylsiloxanes; 1,4-divinyl-1,1,4,4-tetramethyl-1,4-disilabutane; methylbis(trimethylsilyloxy)vinylsilane; 2-(dimethylvinylsilyl)pyridine; tris(2-methoxyethoxy)(vinyl)silane; triacetoxy(vinyl)silane; tris(trimethylsiloxy)(vinyl)silane; 1-cyclopenten-1-yl(trimethyl)silane; trimethyl[(1Z)-1-propyl-1-butenyl]silane; (5,5-dimethyl-1-cyclopententen-1-yl)(trimethyl)silane; trimethyl(6-methyl-1-cyclohexen-1-yl)silane; (4-methoxy-1-cyclohexen-1-yl)(trimethyl)silane; trimethyl(4-methyl-1,5-cyclohexadien-1-yl)silane; trimethyl(5-methyl-1,5-cyclohexadien-1-yl)silane; (6,6-dimethyl-1-cyclohexen-1-yl)(trimethyl)silane; allyl(methyl)1-naphthyl(phenyl)silane; trimethyl(1-phenyl-2-propenyl)silane; 2-cycloocten-1-yl(trimethyl)silane; trimethyl [(2E)-3-phenyl-2-propenyl]silane; trimethyl[2-[(trimethylsilyl)methyl]-2-propenyl]silane; trimethyl(3-phenyl-2-cyclohexen-1-yl)silane; tert-butyldimethyl(2-propynyloxy)silane; dimethyl-di(methacroyloxy-1-ethoxy)silane; trimethoxy(7-octen-1-yl)silane; trimethyl(2,3,4,5-tetramethyl-2,4-cyclopentadien-1-yl)silane; (2-methyl-allyl)-triphenyl-silane; (1-hydroxy-allyl)-tri-methyl-silane; (3-methyl-3-butenyl)(triphenyl)silane; 1-cyclododecen-1-yl(methyl)silane; 1-cyclohepten-1-yl(trimethyl)silane; [2-(cyclohexylmethyl)-2-propenyl](trimethyl)silane; 2-yuclohexen-1-yl(trimethyl)silane; bis(pentafluorophenyl)methyl(alpha-stytyl)silane; tert-butyl(dimethyl)[(2E)-2,4-pentadienyloxy]silane; or combinations thereof.

20. The coupling agent masterbatch of claim 11, wherein the at least one silicon-containing reagent having structure (II) comprises at least one of tetra(alkoxy)silanes; tetramethoxysilane; tetraethoxysilane; tetraisopropoxysilane; tetrabutoxysilane; (alkyl)(alkoxy)silanes; methyl tris(methoxy)silane; methyl tris(ethoxy)silane; methyl tris(isopropoxy)silane; ethyl tris(methoxy)silane; ethyl tris(ethoxysilane); ethyl tris(isopropoxy)silane; propyltris(methoxy)silane; propyl tris(ethoxysilane); propyl tris(isopropoxy)silane; and combinations thereof.

21. A composite comprising:
a) at least one organic peroxide or decomposition product thereof, or residue thereof, wherein the at least one organic peroxide has a half-life of at least one hour at 98° C.;
b) at least one of i) at least one zinc-containing reagent; or residue thereof or reaction product thereof; and/or ii) at least one silicon-containing reagent having structure (I), or residue thereof or reaction product thereof:
SiR¹R²R³R⁴ (I);
wherein at least one of R¹, R², R³, or R⁴ comprises at least one unsaturation and the remaining R¹, R², R³, or R⁴ are hydrogen or alkyl or alkoxy groups and may be the same or different;
c) optionally at least one silicon-containing reagent having structure (II):
SiR⁵R⁶R⁷R⁸ (II);
wherein R⁵, R⁶, R⁷, or R⁸ do not comprise an unsaturation and are hydrogen or alkyl or alkoxy groups and may be the same or different from each other and may be the same of different from the R¹, R², R³, or R⁴ groups that do not contain an unsaturation;
d) at least one polymeric matrix; and
e) at least one filler comprising at least one of wood particles, wood product particles, wood flour, saw dust, rice hull powder, straw powder, straw fibers, wheat straw, bamboo fiber, flax, jute, hemp, cellulose, ground wood, palm fiber, bagasse, peanut shells, chitin, kenaf fibers, scrap paper, cardboard, or combinations thereof.

22. A method of producing a coupling agent masterbatch for cellulosic material-polymer composites, the method comprising:
A) combining:
a) at least one organic peroxide;
b) at least one of i) at least one zinc-containing reagent; and/or ii) at least one silicon-containing reagent having structure (I):
SiR¹R²R³R⁴ (I);
wherein at least one of R¹, R², R³, or R⁴ comprises at least one unsaturation and the remaining R¹, R², R³, or R⁴ are hydrogen or alkyl or alkoxy groups and may be the same or different; and
c) optionally at least one silicon-containing reagent having structure (II):
SiR⁵R⁶R⁷R⁸ (II);
wherein R⁵, R⁶, R⁷, or R⁸ do not comprise an unsaturation and are hydrogen or alkyl or alkoxy groups and may be the same or different from each other and may be the same of different from the R¹, R², R³, or R⁴ groups that do not contain an unsaturation;
to form a coupling agent formulation for cellulosic material-polymer composites;
B) combining the coupling agent formulation for cellulosic material-polymer composites with e) at least one carrier for the coupling agent masterbatch to form the coupling agent masterbatch for cellulosic material-polymer composites.

23. A method of producing a cellulosic material-polymer composite, the method comprising:
I) combining components comprising:
A) the coupling agent for the cellulosic material-polymer composite of claim 1;
B) a polymer matrix; and
C) a filler;
to form a component combination; and
II) forming the component combination into a composite.

24. The method of producing a cellulosic material-polymer composite according to claim 23, wherein step I) further comprises a step of feeding components A), B), and C) to an extruder and step II) comprises a step of extrusion through a die.

25. A method of producing a cellulosic material-polymer composite, the method comprising:
I) combining components comprising:
A) coupling agent masterbatch for cellulosic material-polymer composites according to claim 11;
B) a polymer matrix; and
C) a filler;
to form a component combination; and
II) forming the component combination into a composite.

26. The method of producing a cellulosic material-polymer composite according to claim 25, wherein step I) further comprises a step of feeding components A), B), and C) to an extruder and step II) comprises a step of extrusion through a die.
